(19) United States
(12) Patent Application Publication
(10) Pub. No.: US 2023/0263134 A1
(43) Pub. Date: Aug. 24, 2023

(54) AUTOMATED ANIMAL WASHING DEVICE

(71) Applicant: Daniel Parker, Abingdon, MD (US)

(72) Inventor: Daniel Parker, Abingdon, MD (US)

(21) Appl. No.: 17/677,433

(22) Filed: Feb. 22, 2022

(51) Int. Cl. A01K 13/00

(52) U.S. Cl. CPC A01K 13/001

(57) ABSTRACT

An automated animal washing device, including a main body to receive a pet therein, a plurality of water dispensers disposed within at least a portion of the main body to automatically dispense liquid in a plurality of directions while the pet remains within the main body, and a plurality of fans disposed within at least a portion of the main body to automatically blow air within the main body after the plurality of water dispensers stop dispensing the liquid.

### BACKGROUND

### 1. Field

The present general inventive concept relates generally to pet washing, and particularly, to an automated animal washing device.

### 2. Description of the Related Art

Bathing a pet is an essential component of animal care, but can be a tedious, messy, and/or time-consuming process for the vast majority of pet owners. Moreover, ensuring the animal remains calm and does not bite, scratch, and/or fidget during the bath can be incredibly difficult.

In common practice, most pet owners will hold the pet with one hand while using a hose, brush, and/or a sponge with the other hand. As such, the use of two hands makes it difficult for the pet owner to keep the pet stable during the bath.

Therefore, there is a need for an automated pet washing device that provides a full-service bath including washing and drying, as well as, keeps the pet stable during bathing.

### SUMMARY

The present general inventive concept provides an automated animal washing device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an automated animal washing device, including a main body to receive a pet therein, a plurality of water dispensers disposed within at least a portion of the main body to automatically dispense liquid in a plurality of directions while the pet remains within the main body, and a plurality of fans disposed within at least a portion of the main body to automatically blow air within the main body after the plurality of water dispensers stop dispensing the liquid.

The main body may include a perforated base to facilitate movement of the liquid therethrough and out of the main body, a liquid collecting tray movably disposed within at least a portion of the main body to store the liquid moving through the perforated base thereon, and a head receiving sleeve disposed on at least a portion of the main body to receive a head of the pet therethrough.

The main body may include a plurality of ring connectors disposed within at least a portion of the main body.

The automated animal washing device may further include a harness removably connected to at least a portion of a body of the pet and removably connected to each of the plurality of ring connectors to prevent the pet from moving within the main body.

Each of the plurality of water dispensers may be arcuate shaped and dispense the liquid in a plurality of directions within a one-hundred eighty-degree arc.

Each of the plurality of fans may blow air in a different direction with respect to each other.

The automated animal washing device may further include an external hose disposed on at least a portion of an exterior of the main body to dispense the liquid therefrom.

The automated animal washing device may further include a cleaning agent container disposed on and within at least a portion of the main body to receive a cleaning agent therein, and dispense the cleaning agent into each wall of the main body to mix the cleaning agent with the liquid.

The automated animal washing device may further include a liquid inlet disposed on at least a portion of the main body to receive the liquid therein to provide a source of the liquid into the main body, and a liquid outlet disposed on at least a portion of the main body to facilitate extraction of the liquid from the main body.

The automated animal washing device may further include a control unit disposed on at least a portion of the main body to control at least one of the plurality of water dispensers and the plurality of fans.

The control unit may automatically select different wash cycles based on a size and a weight of the pet.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric top view of an automated animal washing device, according to an exemplary embodiment of the present general inventive concept; and

FIG. 2 illustrates an isometric view of an animal harness, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Automated Animal Washing Device 100
Main Body 110
Perforated Base 111
Filter 112
Liquid Collecting Tray 113
Head Receiving Sleeve 114
Lid 115
Handle 116
Ring Connectors 117
Water Dispensers 120
Fans 130
External Hose 140
Cleaning Agent Container 150
Liquid Inlet 160
Liquid Outlet 170
Control Unit 180
Harness 190
Wearable Body 191
Straps 192
Fasteners 193

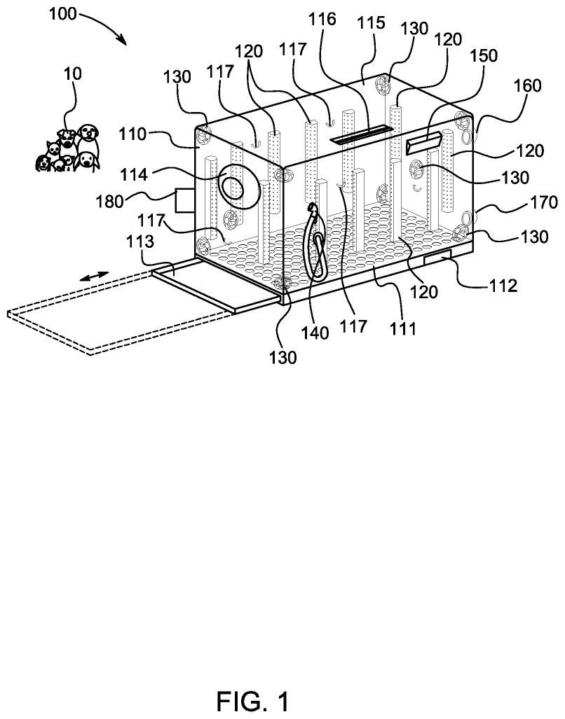

FIG. 1 illustrates an isometric top view of an automated animal washing device 100, according to an exemplary embodiment of the present general inventive concept.

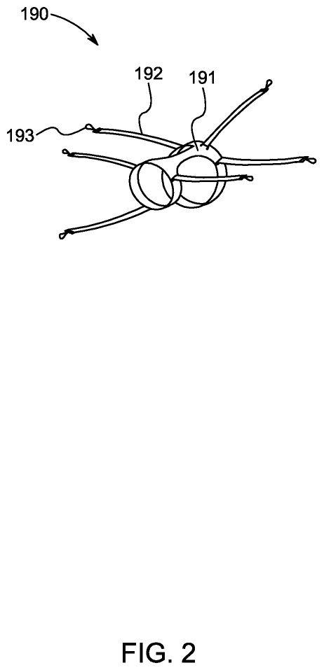

FIG. 2 illustrates an isometric view of an animal harness 190, according to an exemplary embodiment of the present general inventive concept.

The automated animal washing device 100 may be constructed from at least one of glass, metal, plastic, wood, and rubber, etc., but is not limited thereto.

Referring to FIGS. 1 and 2, the automated animal washing device 100 may include a main body 110, a plurality of water dispensers 120, a plurality of fans 130, an external hose 140, a cleaning agent container 150, a liquid inlet 160, a liquid outlet 170, a control unit 180, and a harness 190, but is not limited thereto.

Referring again to FIG. 1, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto.

The main body 110 may have a variety of sizes. In particular, the main body 110 may be small, medium, and large, such that small is the smallest size, large is the largest size, and medium is in between. Alternatively, the main body 110 may be constructed as a custom fit based on a size of a pet 10.

Each wall of the main body 110 may have a plurality of layers to allow liquid to move therein. Alternatively, the main body 110 may be constructed with a plurality of tubes and/or a plurality of hoses within each wall of the main body 110.

The main body 110 may include a perforated base 111, a filter 112, a liquid collecting tray 113, a head receiving sleeve 114, a lid 115, a handle 116, and a plurality of ring connectors 117, but is not limited thereto.

The perforated base 111 may have a plurality of apertures disposed thereon. Additionally, the perforated base 111 may be disposed on at least a portion of a bottom of the main body 110. The perforated base 111 may facilitate movement of a liquid (e.g, water) therethrough and out of the main body 110.

Furthermore, the perforated base 111 may be adjustable in height. Specifically, the perforated base 111 may be perpendicularly moved in a direction in parallel with each of a plurality of walls of the main body 110. In other words, the perforated base 111 may be moved toward or away from a top of the main body 110. As such, the perforated base 111 may accommodate different size pets thereon based on a height of the pet 10.

The filter 112 may be removably connected within at least a portion of the main body 110. The filter 112 may cleanse and/or decontaminate the liquid moving within the main body 110.

The liquid collecting tray 113 may be movably (i.e., slidably) disposed within at least a portion of the main body 110. The liquid collecting tray 113 may store the liquid moving through the perforated base 111 thereon. As such, the liquid collecting tray 113 may be extracted from the main body 110 after cleaning to remove (i.e., pour) the liquid from the liquid collecting tray 113.

The head receiving sleeve 114 may be disposed on at least a portion of the main body 110. The head receiving sleeve 114 may be an aperture. Additionally, the head receiving sleeve 114 may have a cushion and/or have a smooth texture, such as silk and/or feathers to comfort the pet 10. The head receiving sleeve 114 may receive a head of the pet 10 therethrough.

The lid 115 may be hingedly disposed on at least a portion of the main body 110. The lid 115 may move (i.e., pivot, rotate) from closed in a first position to at least partially opened in a second position. Conversely, the lid 115 may move from opened in the second position to closed in the first position. Thus, the lid 115 may facilitate access within the main body 110 in the opened position, and prevent access within the main body 110 in the closed position. Also, the main body 110 may receive the pet 10 therein while the lid 115 is opened.

The handle 116 may be disposed on at least a portion of the lid 115. The handle 116 may facilitate gripping thereof.

Referring again to FIG. 1, each of the plurality of ring connectors 117 are illustrated to be a ring. However, each of the plurality of ring connectors 117 may be a clamp, a clip, a clasp, an adhesive (e.g., tape, glue), a magnet, and/or any combination thereof, but is not limited thereto.

The plurality of ring connectors 117 may be disposed within at least a portion of the main body 110. Each of the plurality of ring connectors 117 may receive an attachment thereto.

The plurality of water dispensers 120 may be disposed within at least a portion of the main body 110. Each of the plurality of water dispensers 120 may be arcuate shaped, such that each of the plurality of water dispensers 120 may automatically dispense liquid in a plurality of directions in an arcuate shape (e.g., within a one-hundred eighty-degree arc). Moreover, each of the plurality of water dispensers 120 may be connected to each wall of the main body 110, such that the plurality of water dispensers 120 may receive the liquid therefrom. Accordingly, the plurality of water dispensers 120 may wash the pet 10 within the main body 110 from the plurality of directions, and provide a thorough wash. It is important to note that the plurality of water dispensers 120 may dispense the liquid in an arcuate because they do not move as that would increase a number of moving parts and cause more maintenance.

The plurality of fans 130 may be disposed within at least a portion of the main body 110. Each of the plurality of fans 130 may automatically blow air within the main body 110. Moreover, each of the plurality of fans 130 may blow the air in a different direction with respect to each other. Also, the plurality of fans 130 may activate only after the plurality of water dispensers 120 have completed (e.g., stopped) dispensing the liquid. Accordingly, the plurality of fans 130 may dry the pet 10 within the main body 110 from the plurality of directions.

The external hose 140 may include a nozzle and a handle, but is not limited thereto.

The external hose 140 may be disposed on at least a portion of an exterior of the main body 110. The external hose 140 may be connected to at least one wall of the main body 110, such that the external hose 140 may receive the liquid therefrom. Additionally, the external hose 140 may dispense the liquid from the nozzle in response to depressing (i.e., squeezing) the handle. Therefore, the external hose 140 may spray the liquid onto the head of the pet 10 to wash the head of the pet 10.

The cleaning agent container 150 may be disposed on and/or within at least a portion of the main body 110. The cleaning agent container 150 may be opened to receive a cleaning agent (e.g., soap, shampoo, conditioner, insect treatment, etc.) therein. Moreover, the cleaning agent container 150 may dispense the cleaning agent into each wall of the main body 110 to mix the cleaning agent with the liquid, such that the pet 10 may be washed with the cleaning agent.

The liquid inlet 160 may be disposed on at least a portion of the main body 110. The liquid inlet 160 may be an inlet aperture to receive a first external hose thereon. For example, the liquid inlet 160 may receive the liquid (e.g., water) from the first external hose to provide a source of the liquid into the main body 110.

The liquid outlet 170 may be disposed on at least a portion of the main body 110. The liquid outlet 170 may be an outlet aperture to receive a second external hose thereon. As such, the liquid outlet 170 may facilitate extraction of the liquid from the main body 110. In other words, the liquid within the main body 110 may exit through the liquid outlet 170.

The control unit 180 may include a knob, a dial, a switch, a heating coil, and a power source (e.g., a power inlet, a battery, a solar cell), but is not limited thereto.

The control unit 180 may be disposed on at least a portion of the main body 110. The control unit 180 may control the plurality of water dispensers 120 and/or the plurality of fans 130. For example, the control unit 180 may adjust a number of the plurality of water dispensers 120 and/or a number of the plurality of fans 130 in use during bathing of the pet 10. Moreover, the control unit 180 may adjust a speed level of each of the plurality of water dispensers 120 and/or a speed level of each of the plurality of fans 130, such that the plurality of water dispensers 120 may dispense the liquid softer (i.e., slower) and/or harder (i.e., faster) depending on the speed level of each of the plurality of water dispensers 120. Similarly, the plurality of fans may rotate slower and/or faster depending on the speed level of each of the plurality of fans 130. It is important to note that the speed level of each of the plurality of water dispensers 120 may differ with respect to each other. Also, the speed level of each of the plurality of fans 130 may differ with respect to each other.

The control unit 180 may provide power to the plurality of water dispensers 120 and/or the plurality of fans 130.

Furthermore, the control unit 180 may automatically and/or be used to manually select different wash cycles, such as mixing the cleaning agent into the liquid to wash the pet 10, rinse only with the cleaning agent added from the cleaning agent container 150, and/or drying only, such that the plurality of fans 130 may blow the air to dry the pet 10. Also, the control unit 180 may adjust a temperature level (i.e., cold, warm, hot) of the liquid. Lastly, the control unit 180 may adjust washing and/or drying based on the size (e.g., length, height) and/or a weight of the pet 10.

The harness 190 may include a wearable body 191, a plurality of straps 192, and a plurality of fasteners 193, but is not limited thereto.

The wearable body 191 may be removably connected to at least a portion of a body of the pet 10. The wearable body 191 may secure the pet therein.

Each of the plurality of straps 192 may be disposed at a first end on at least a portion of the wearable body 191. Moreover, each of the plurality of straps 192 may extend away from the wearable body 191.

Referring again to FIG. 2, each of the plurality of fasteners 193 is illustrated to be a hook. However, each of the plurality of fasteners 193 may be a clamp, a clip, a clasp, an adhesive (e.g., tape, glue), a magnet, and/or any combination thereof, but is not limited thereto.

Each of the plurality of fasteners 193 may be disposed on at least a portion of a second end corresponding to each of the plurality of straps 192. Each of the plurality of fasteners 193 may be removably connected to at least one of the plurality of ring connectors 117. As such, the plurality of fasteners 193 may prevent the pet 10 from moving within the main body 110 while the plurality of fasteners 193 remain connected to the plurality of ring connectors 117 (i.e., connected to the main body 110).

Therefore, the automated animal washing device 100 may wash and/or dry the pet 10 in a stable manner. Moreover, the automated animal washing device 100 may minimize time for an owner, a groomer, and/or a veterinarian to clean the pet 10 without risk of injury to the pet 10.

The present general inventive concept may include an automated animal washing device 100, including a main body 110 to receive a pet 10 therein, a plurality of water dispensers 120 disposed within at least a portion of the main body 110 to automatically dispense liquid in a plurality of directions while the pet 10 remains within the main body 110, and a plurality of fans 130 disposed within at least a portion of the main body 110 to automatically blow air within the main body 110 after the plurality of water dispensers 120 stop dispensing the liquid.

The main body 110 may include a perforated base 111 to facilitate movement of the liquid therethrough and out of the main body 110, a liquid collecting tray 113 movably disposed within at least a portion of the main body 110 to store the liquid moving through the perforated base 111 thereon, and a head receiving sleeve 114 disposed on at least a portion of the main body 110 to receive a head of the pet 10 therethrough.

The main body 110 may include a plurality of ring connectors 117 disposed within at least a portion of the main body 110.

The automated animal washing device 100 may further include a harness 190 removably connected to at least a portion of a body of the pet 10 and removably connected to each of the plurality of ring connectors 117 to prevent the pet 10 from moving within the main body 110.

Each of the plurality of water dispensers 120 may be arcuate shaped and dispense the liquid in a plurality of directions within a one-hundred eighty-degree arc.

Each of the plurality of fans 130 may blow air in a different direction with respect to each other.

The automated animal washing device 100 may further include an external hose 140 disposed on at least a portion of an exterior of the main body 110 to dispense the liquid therefrom.

The automated animal washing device 100 may further include a cleaning agent container 150 disposed on and within at least a portion of the main body 110 to receive a cleaning agent therein, and dispense the cleaning agent into each wall of the main body 110 to mix the cleaning agent with the liquid.

The automated animal washing device 100 may further include a liquid inlet 160 disposed on at least a portion of the main body 110 to receive the liquid therein to provide a source of the liquid into the main body 110, and a liquid outlet 170 disposed on at least a portion of the main body 110 to facilitate extraction of the liquid from the main body 110.

The automated animal washing device 100 may further include a control unit 180 disposed on at least a portion of the main body 110 to control at least one of the plurality of water dispensers 120 and the plurality of fans 130.

The control unit 180 may automatically select different wash cycles based on a size and a weight of the pet 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An automated animal washing device, comprising:
a main body to receive a pet therein;
a plurality of water dispensers disposed within at least a portion of the main body to automatically dispense liquid in a plurality of directions while the pet remains within the main body; and
a plurality of fans disposed within at least a portion of the main body to automatically blow air within the main body after the plurality of water dispensers stop dispensing the liquid.

2. The automated animal washing device of claim 1, wherein the main body comprises:
a perforated base to facilitate movement of the liquid therethrough and out of the main body;
a liquid collecting tray movably disposed within at least a portion of the main body to store the liquid moving through the perforated base thereon; and
a head receiving sleeve disposed on at least a portion of the main body to receive a head of the pet therethrough.

3. The automated animal washing device of claim 1, wherein the main body comprises:
a plurality of ring connectors disposed within at least a portion of the main body.

4. The automated animal washing device of claim 3, further comprising:
a harness removably connected to at least a portion of a body of the pet and removably connected to each of the plurality of ring connectors to prevent the pet from moving within the main body.

5. The automated animal washing device of claim 1, wherein each of the plurality of water dispensers are arcuate shaped and dispense the liquid in a plurality of directions within a one-hundred eighty-degree arc.

6. The automated animal washing device of claim 1, wherein each of the plurality of fans blow air in a different direction with respect to each other.

7. The automated animal washing device of claim 1, further comprising:
an external hose disposed on at least a portion of an exterior of the main body to dispense the liquid therefrom.

8. The automated animal washing device of claim 1, further comprising:
a cleaning agent container disposed on and within at least a portion of the main body to receive a cleaning agent therein, and dispense the cleaning agent into each wall of the main body to mix the cleaning agent with the liquid.

9. The automated animal washing device of claim 1, further comprising:
a liquid inlet disposed on at least a portion of the main body to receive the liquid therein to provide a source of the liquid into the main body; and
a liquid outlet disposed on at least a portion of the main body to facilitate extraction of the liquid from the main body.

10. The automated animal washing device of claim 1, further comprising:
a control unit disposed on at least a portion of the main body to control at least one of the plurality of water dispensers and the plurality of fans.

11. The automated animal washing device of claim 10, wherein the control unit automatically selects different wash cycles based on a size and a weight of the pet.
